(19) United States
(12) Patent Application Publication
(10) Pub. No.: US 2010/0214252 A1
(43) Pub. Date: Aug. 26, 2010

(54) Touch panel component for capacitive panel

(76) Inventor: Mao-Sung Wu, Lujhu Township (TW)

Correspondence Address: Jackson Intellectual Property Group PLLC, 106 Starvale Lane, Shipman, VA, 22971, US

(21) Appl. No.: 12/000,658

(22) Filed: Dec. 14, 2007

(51) Int. Cl. G06F 3/045; G06F 3/033

(52) U.S. Cl. 345/174; 345/179

(57) ABSTRACT

The touch component of the present invention is consisted of the main body. The said main body is a conductor used for changing current. The said main body at least includes a hand held portion and a touch portion. The said hand held portion is the part for human to hold in the hand; whereas the touch portion is for contacting with the capacitive panel. When user is using the device, the hand is holding the hand held portion of the touch component. At the same time, the conduction of electricity through the touch component could be capacitive-coupled with the electric field on the conductive layer outside the panel, then the human body will attract the minute electrical current so that the electrode could detect the electric current for touch panel operation.

### BACKGROUND OF THE INVENTION

(a) Field of the Invention

The present invention is related to the design of a touch component for capacitive panel, and more particularly to using a touch component to transmit current to human body.

(b) Description of the Prior Art

The touch panel market based on the physics principle of detecting touch point can be divided into: resistor type whereas the finger or other kind of touch head tips on the panel to create voltage; or the capacitive type whereas the finger is used to attract minute amount of current (usually used on the touch screen panel of notebook PC).

The top layer of the resistive touch panel is a layer of polyester film, the inner side of which has conductive metal coating. The bottom layer of the screen, to be pasted on CRT or LCD screen, is a piece of glass spread with conductive material. Between the glass and the polyester film a layer of minute separating point made of polyester is used for separation. Along the X-axis of the glass plate and the Y-axis of the polyester film there is a controller for each that will apply minute voltage gradient. Whenever the finger or a general-purpose touch pen touches the screen, the two conductive layers will be pressed together and the electronic device could detect the X- and Y-coordinate of the touch point.

In the market in general most touch screen panels are using touch pen to control the screen. However; the said touch pen requires pressing of the point for the control. Therefore, user often will leave a dark damaged mark on the touch panel screen using resistive touch panel technology because of excessive pressure applied. FIG. 1 shows a conventional resistive type touch pen comprising a pen body, one end of the pen body B is a touch pen head B1, wherein the said touch pen is a nonconductive plastic pen but require pressure for conducting operation in order to detect the X- and Y-coordinates of the touch point to achieve the purpose of touch panel control.

The innovative iPhone design presently available in the market is the combination of technology and humanity. Therefore, the circuit used in iPhone is a more complicated capacity touch panel screen. The glass plate of the capacitive touch panel screen has conductive material coated on both sides and outer side is coated with anti-scratch film. The electrodes on the peripheral of glass plate will generate an even, low voltage, electrical field on the outer conductive layer; the inner conductive layer could provide electromagnetic shield and reduce noise. Whenever the finger touches the screen, it will capacitor-couple with the electrical field on the outer conductive layer and attract the minute current. Each electrode is responsible for measuring the current from each corner for the controller to find out the coordinates of the finger. Therefore, comparing the capacitive panel with the older resistive touch panel the said capacitive panel, which could generate capacitor coupling for the detection of touch position through detecting electrical current, as human body is a good conductor, the capacitive panel can only rely on the human body or conductive object to be in touch with the changing current to achieve the result of touch panel.

Therefore, the iPhone products will not be sensitive to conventional touch pen as the conventional touch pen is not conductive and only the conductive skin of the finger can be used for conducting the operation. However, as the area of the finger has larger range, user often might select other items because of the narrow and fine selection items and result in confusion of user's operation. There is still room for improvement for such technology.

### SUMMARY OF THE INVENTION

In view of this, this invention provides a kind of touch panel control component for use in capacitive panel in order to resolve the conventional problem of touch pen not able to be used in capacitive panel.

To achieve the above stated purpose for this invention in order to meet the touch panel control component of this invention, the main body of the said touch panel component is a conductor as the body for conducting electrical current. The said main body comprises at least a hand held portion and a touch portion; wherein, the said hand held portion is portion for the ease of a person to hold in hands; whereas the said touch portion is for the contact with a capacitive panel so that the user could operate the said panel using touch component. When a user uses the device and the hand is holding the hand held portion of the touch component, the touch component can also conduct electrical current and capacitive-couple with the electrical field on the conductive layer at the outer side of the panel, thus allowing the human body to attract the minute amount of electrical current in order for the electrode to detect electrical current and conduct touch panel operation. This invention is for the replacement of the conventional hand operating method and facilitate user to easily select the desired program or file from a complicated and fine selection list.

A further purpose of this invention is for combination with a flexible unit and a universal connector head design so as to make this invention more adaptive to other designs.

### BRIEF DESCRIPTION OF THE DRAWINGS

FIG. 1 is a perspective view of prior art.

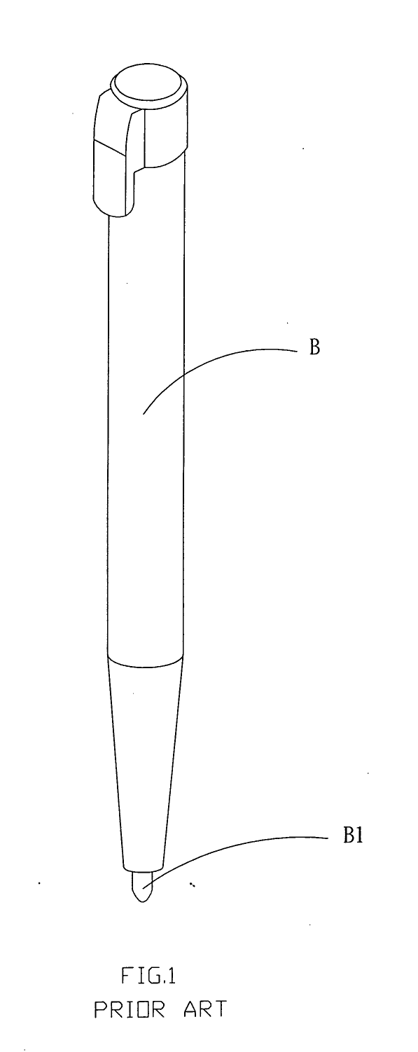

FIG. 2 is a perspective view showing the first preferred embodiment of the present invention of touch component in the application of capacitive panel.

FIG. 3 is a perspective view of the touch component showing the second preferred embodiment of the present invention in the application of capacitive panel.

FIG. 4 is a perspective view of the third preferred embodiment of the present invention in the touch component application for capacitive panel.

FIG. 5 is a perspective view of the fourth preferred embodiment of the present invention in the touch component application for capacitive panel.

FIG. 6A is a perspective view of the fifth preferred embodiment of the present invention in the touch component application for capacitive panel.

FIG. 6B is an enlarged perspective view of the fifth preferred embodiment of the present invention in the touch component application is for capacitive panel in combination with a universal connecting head.

FIG. 7 is a perspective view of the sixth preferred embodiment of the present invention in the touch component application for capacitive panel.

FIG. 8 is an illustration of the actual use of touch component for the application of capacitive panel.

FIG. 9A is a perspective view of the seventh preferred embodiment of the present invention in the touch component application for capacitive panel.

FIG. 9B is an illustration of the actual use of seventh preferred embodiment of the present invention in the touch component application for capacitive panel.

### DETAILED DESCRIPTION OF THE PREFERRED EMBODIMENTS

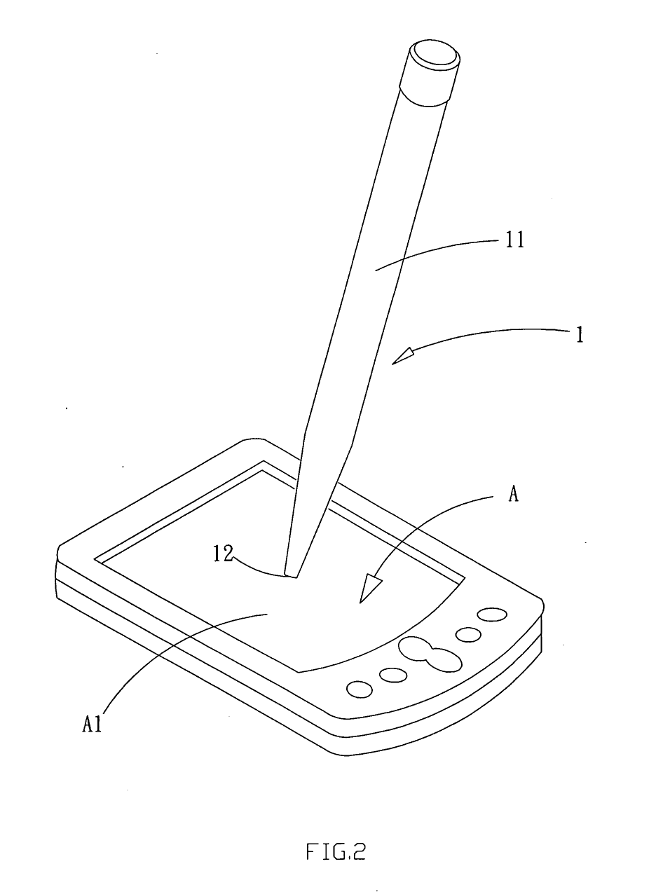

The basic structure of this invention in the application of “touch component for capacitive panel” is schematically shown in FIG. 2. The said touch component is mainly made of the main body 1; the said main body 1 is a conductor for the use of a conductive body for the use to operate the said panel A through a touch component. The said main body comprises at least a hand held portion 11 and a touching portion 12; wherein the said hand held portion 11 is the portion for the human body's convenience to hold on; and the said touch portion 12 is for the contact with the capacitive panel A so that the user could use the touch component to control the said panel A. When user is using the device, the hand will take hold of the hand held portion 11 of the touch component to control the touch panel A and at the same time could cause capacitive-coupling with the electrical field generated on the conductive layer of the outer side of the panel A and then the human body will attract the minute electrical current so that the electrode could detect the electrical current in order to conduct touch panel operation.

In the embodiment illustrated in this figure, the human body is a conductor and both sides of the glass plate A1 of the touch panel screen of the capacitive panel A are spread with conductive material, the electrodes surrounding the glass plate A1 will generate evenly distributed low voltage electrical field on the outer conduction layer; the inner conduction layer will provide electromagnetic shielding and reduce noise. Therefore, whenever the finger is in touch with the screen it will cause capacitive-coupling with the electrical field on the outer conductive layer and attracts minute amount of current. Each electrode is responsible for the measurement of electrical current from each corner in order for the controller to determine the coordinates of the finger. Therefore, the capacitive panel A can only react to the human body or the touch of conductive object. Hence the said main body 1 of the stated touch component of this embodiment is made of conductive metal material. The main body of this invention can also be conductive plastics. And through the user holding the hand held portion 11, use of the touch portion 12 of the touch component to contact the capacitive panel A will activate the operation.

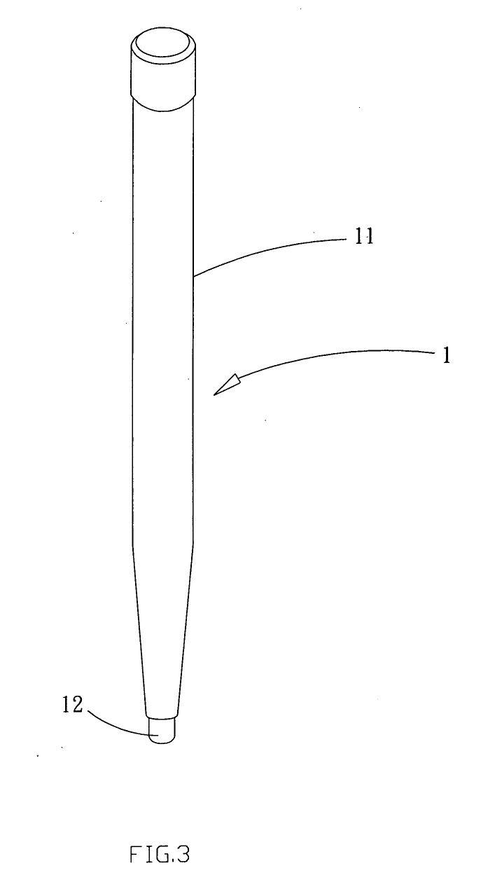

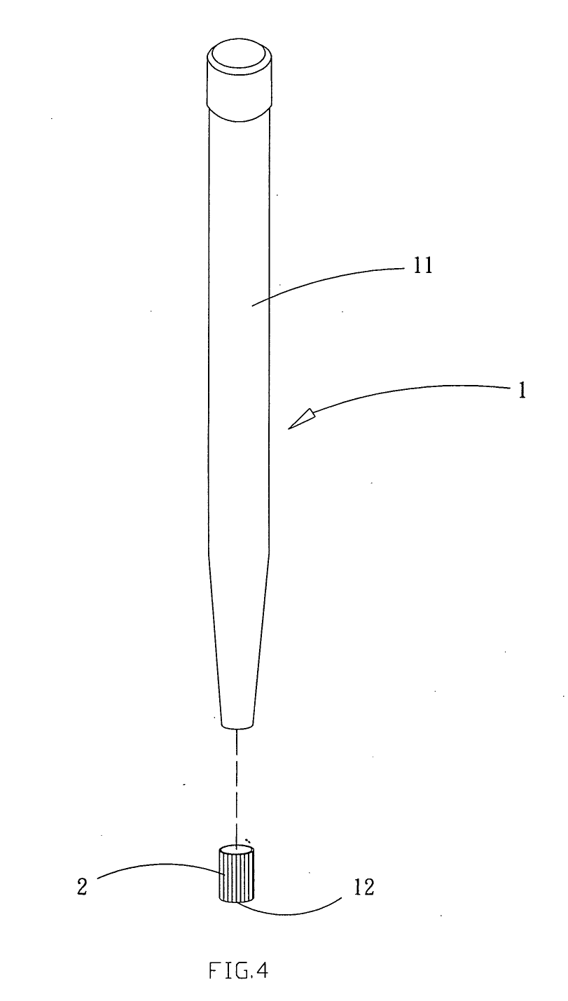

In addition to the embodiment configured as flat touch portion 12 as shown in FIG. 2, this touch component can also be installed configured as U-shape touch portion 12 of the second embodiment as shown in FIG. 3. Whether the touch portion 12 is flat or U-shape that could form one-body with the main body 1, they can also be formed separately and combined later or as shown in FIG. 4, which is the illustration of the third embodiment, by installing a protection sleeve 2 slotting on the main body 1. The said protection sleeve 2 can be a conductive rubber or conductive plastics so that the added protection sleeve 2 can further protect the capacitive panel A from scratches in addition to the original touch function for the touch component.

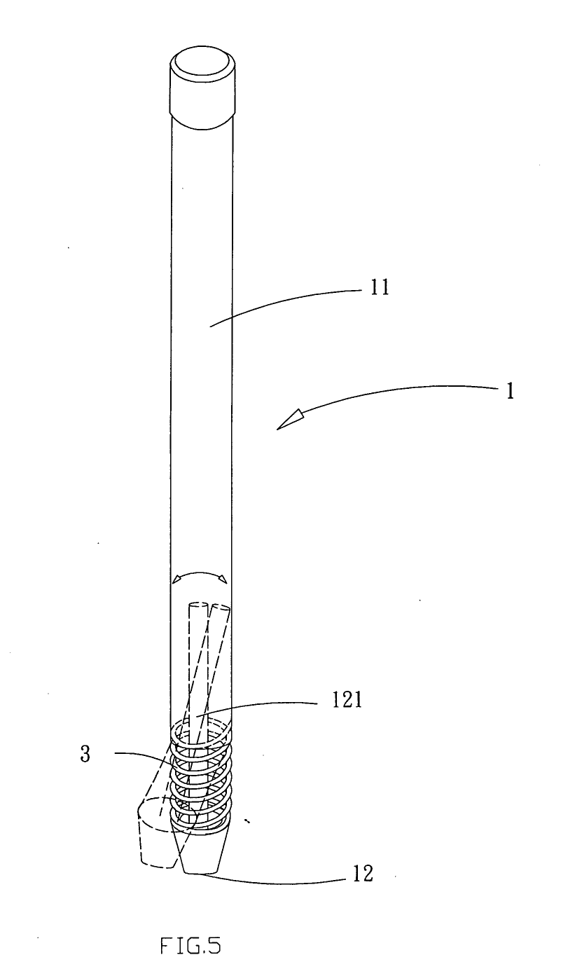

Naturally the said touch component can further contain a flexible conductive element 3 in the fourth embodiment as shown in FIG. 5. The said flexible element 3 can be a spring made of wounded material. One side of the flexible element 3 is connected to the main body 1 while the other side corresponding to the main body 1 is connected to the touch portion 12. The said touch portion 12 is installed with a limiting portion 121, whereas the limiting portion 121 goes through the flexible element 3 within the main body 1.

As shown in the illustration, when the said touch portion 12 is in contact with the capacitive panel A, through adjusting the angle of the flexible element 3, by wobbling the touch portion 12 right or left, the limiting portion 121 will touch the peripheral of main body 1 at the limiting angular position without excessively large adjusting angle while the touch portion 12 can be guided to contact the capacitive panel A correctly and smoothly.

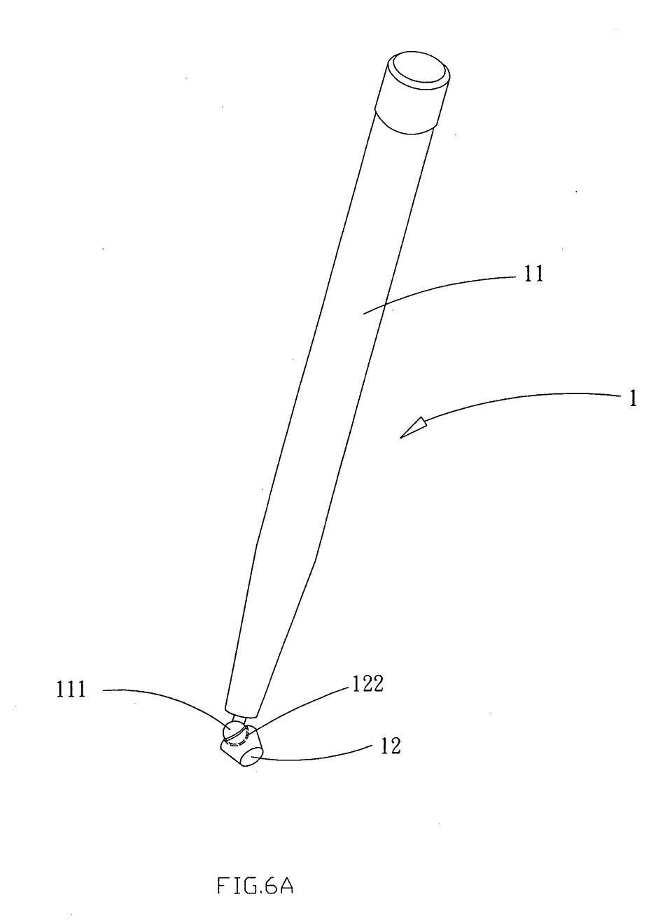

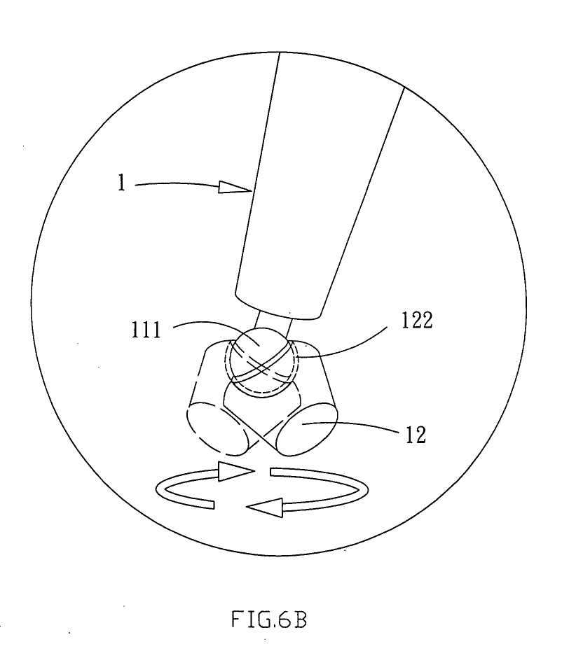

Again, as shown in FIGS. 6A and 6B showing the fifth embodiment, the said touch portion 12 can be further connected to a universal contacting head. The said touch portion 12 is installed with a slotting connection portion 122, wherein one side of the main body 1 is installed with a pivoting part 111. The pivoting part 111 is in a spherical shape and slotting into the slotting connection portion 122 for the pivoting part 111 can rotate in all directions at the slotting portion 122 by adjusting the angle, so that the touch portion 12 is not restricted to dead angle for the user to flexibly control touch portion 12 at any angle and the touch portion 12 can be guided to contact the capacitive panel A correctly and smoothly.

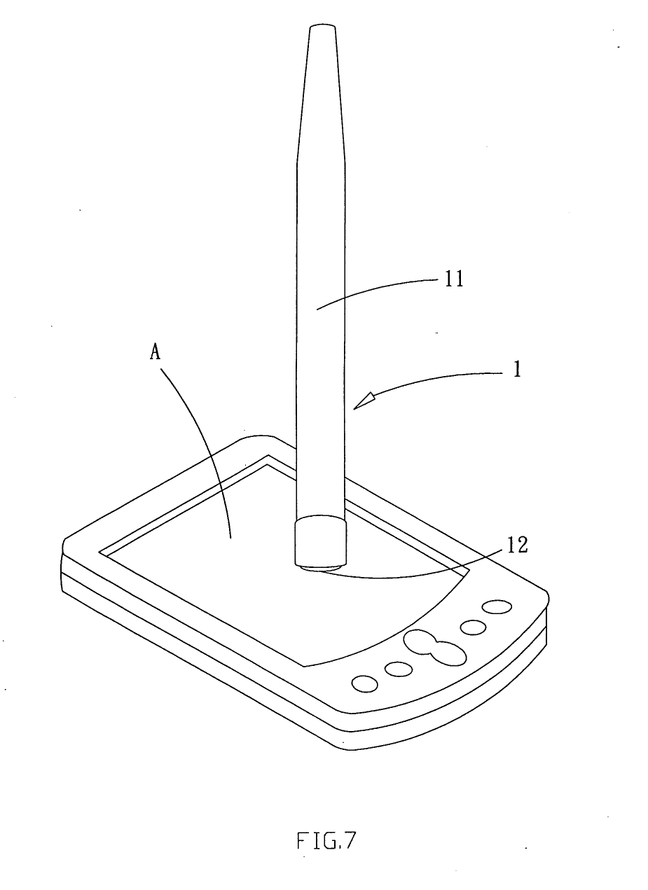

Naturally, as shown in FIG. 7, which shows the sixth embodiment of the invention. This invention is not limited in using one side of the main body 1 as touch portion 12. Both sides of the main body 1 can be used for the operation.

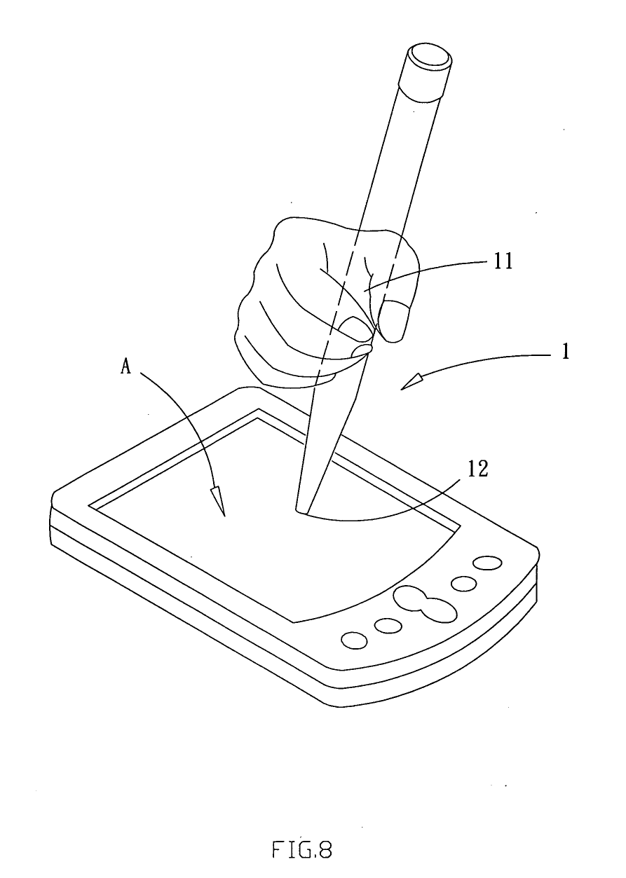

In the practical situation, FIG. 8 shows the user is contacting the touch component using his hand. The hand held portion 11 of the main body 1 of this invention allows the said touch portion 12 to contact the capacitive panel A so that the user could operate the said panel A through operating the said touch component. When user is using the device, the hand is holding the hand held portion 11 of the touch component to control the panel A. Alternatively, through the conduction of current, the conduction of touch component can capacitive-couple the electrical field from the outer conduction layer on the panel A and then attract the minute electrical current so that the electrode can detect the current and perform touch panel operation. Such is for replacing the conventional hand operational method and facilitate the user in selecting the desired program or file from complicated and fine selection menu.

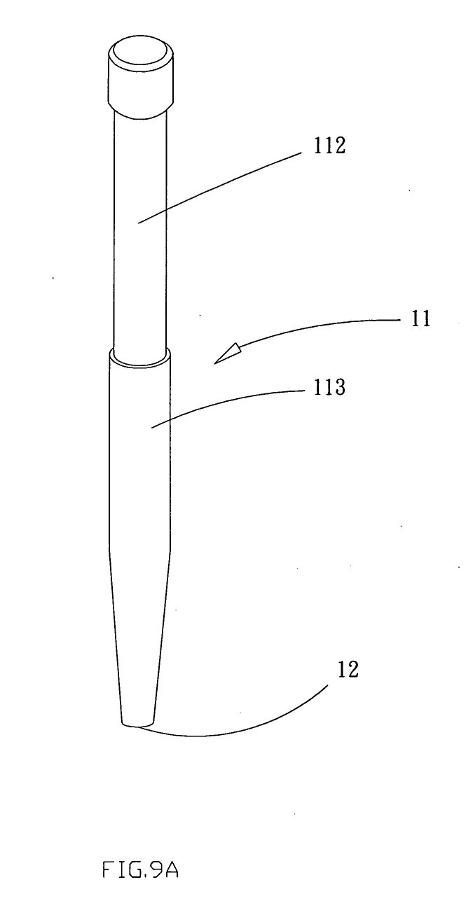

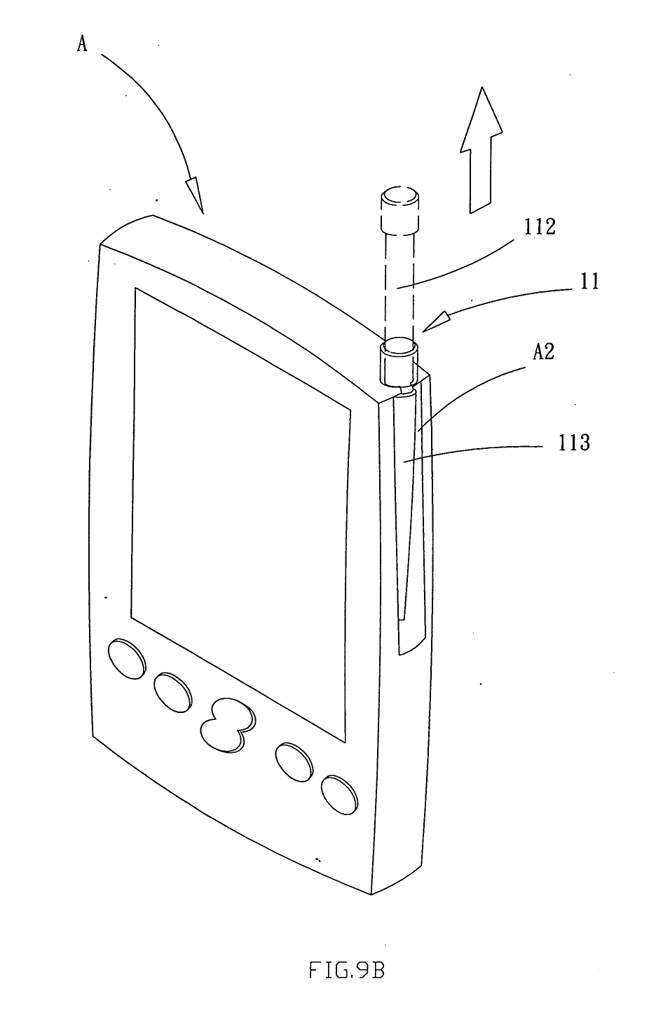

Again, to meet the requirement of portability and accommodating the shape design of the capacitive panel A this invention further can be a stretchable touch panel design. Please refer to the illustration of FIGS. 9A and 9B showing the seventh embodiment of this invention. The hand held portion 11 of the said touch component can further split into the stretching portion 112 and the stretching mouth 113. The said stretching portion 112 is connected to the stretching mouth 113 having stretching function. When user holds the stretching touch component to perform operating function or writing the stretching portion 112 can be extended for user's ease to hold. On the other hand, the stretching portion 112 can be pressed down and restore to inside of the stretching mouth 113 when not in use so as to reduce the length of the stretching portion 112 and increase the convenience of enclosure and portability.

Naturally, to accommodate the device in the use on capacitive panel A, a storage slot A2 is provided for storing the touch component. When the said touch component is not in use, the stretching portion 112 can be depressed into the stretching mouth 113 and placed into the storage slot A2 on the capacitive panel A so that the length of the touch component can be reduced and matches the requirement of the shape of the capacitive panel A. Once more, when user needs to use the touch component, the touch component can be pulled out from the storage slot A2 and the stretching portion 112 can be stretched from the stretching mouth 113 so that the touch component can be stretched in length to facilitate user in holding the device.

One thing worth mentioning is that the present invention has the following advantages as compared to the prior art:
1. The present invention replaces the conventional hand held contact capacitive panel operation.
2. The present invention facilitates user in easy selection of desired programs or files from complicated and fine selection menu.
3. The flexible unit and universal connection head design of the present invention can guide the touch portion to contact the capacitive panel correctly and smoothly.
4. The touch component of the present invention is not limited in using one side to perform operation and instead both sides can be used for operating instructions.
5. The touch component of the present invention can provide stretching design for proper storage after use.

As stated above, the present invention provides a preferred and feasible “Touch component for capacitive panel”. I hereby submit the application for new patent. The above description in the implementation and illustration is the preferred embodiment of the present invention and is not limited to this invention. Hence all structures, devices, and features having similar or close design to the present invention should all covered by the purpose and range of patent application of the present invention.

1. A touch component for use in capacitive panel; the main body of the said touch panel is a conductor; the said main body comprises at least:
a hand held portion, for providing holding of the device;
a touch portion, for contacting with capacitive panel.

2. A touch component for used in capacitive panel as claimed in claim 1, wherein the said main body is metallic or conductive plastics material.

3. A touch component for used in capacitive panel as claimed in claim 1, wherein the said touch portion forms one body or separately with the main body.

4. A touch component for used in capacitive panel as claimed in claim 1, wherein the said touch portion is flat or U shape.

5. A touch component for used in capacitive panel as claimed in claim 1, wherein the said touch portion is a protection sleeve.

6. A touch component for used in capacitive panel as claimed in claim 5, wherein the said protection sleeve is conductive rubber or conductive plastics.

7. A touch component for used in capacitive panel as claimed in claim 1, wherein the said touch component further comprises a conductive flexible unit.

8. A touch component for used in capacitive panel as claimed in claim 7, wherein the said flexible unit can be a spring made of wounded material.

9. A touch component for used in capacitive panel as claimed in claim 1, wherein the said touch portion can be combined with a universal connector head.

10. A touch component for used in capacitive panel as claimed in claim 1, wherein the said touch component can further be stretchable type.
